(19) United States
(12) Patent Application Publication
(10) Pub. No.: US 2022/0376230 A1
(43) Pub. Date: Nov. 24, 2022

(54) Fe3C-DOPED GRADED POROUS CARBON POLYMER POTASSIUM ION ANODE MATERIAL, PREPARATION METHOD AND APPLICATION THEREOF

(71) Applicant: GUANGDONG UNIVERSITY OF TECHNOLOGY, GUANGZHOU (CN)

(72) Inventors: Miao HE, GUANGZHOU (CN); Yandong XIE, GUANGZHOU (CN); Yefeng FENG, GUANGZHOU (CN); Deping XIONG, GUANGZHOU (CN)

(21) Appl. No.: 17/315,535

(22) Filed: May 10, 2021

(51) Int. Cl. H01M 4/36; H01M 10/054; H01M 4/58; H01M 4/587; C04B 35/524; C04B 35/52; C04B 35/64

(52) U.S. Cl. CPC H01M 4/366; H01M 10/054; H01M 4/58; H01M 4/587; C04B 35/524; C04B 35/522; C04B 35/64; H01M 2004/027

(57) ABSTRACT

The disclosure relates to a Fe₃C-doped graded porous carbon polymer potassium ion anode material as well as a preparation method and application thereof. In the method, previously prepared Fe₂O₃ is added into phenylamine, pyrrole, thiophene and cellulose acetate solutions, the above mixture is evaporated at the low temperature of 65-100° C., and then the evaporated product is calcinated to obtain a potassium battery anode material. This material consists of carbon nano sheets having different pore diameters, and has a graded porous structure of micropores, mesopores and macropores. Physical characterization results show that this material has the characteristics of large interlayer spacing, high specific surface area, rich defects and the like; electrochemical testing results show that this material has high reversible capacity and excellent cycle stability and rate performance.

### TECHNICAL FIELD

The disclosure relates to the technical field of potassium ion batteries, particularly to a Fe₃C-doped graded porous carbon polymer material as a high-energy density potassium ion battery anode of an anode active substance and a preparation method thereof.

### BACKGROUND OF THE PRESENT DISCLOSURE

As the scientific and technological level is rapidly developed, people have increasing demands for portable energy storage devices, and meanwhile propose a higher requirement on a new-generation energy storage device. In many portable energy storage devices, a potassium ion battery has drawn more attentions due to its rich potassium resource and low cost. The redox potential (−2.93V vs E°) of K/K⁺ is close to the redox potential (−3.04 V vs E°) of Li/Li⁺, indicating that the potassium ion battery has higher discharge voltage platform and energy density. However, the original large size of the potassium ion makes the electromigration rate of the potassium ion low, and then the continuous redox reaction of the anode material in the processes of charge and discharge causes the volume of the material to be increased so as to affect the energy storage performance of the material, and therefore development of a novel potassium ion battery anode material, which has low cost, high capacity, excellent stability and rate performance, is of importance to large-scale use of the potassium ion battery.

In many anode materials, a carbon material is the most promising potassium ion battery anode material due to its high theory specific capacity and a wide working voltage of 0.3 V vs K⁺/K. In addition, a transition metallic element has always been considered as the best potassium ion battery material due to large theory specific capacity. By compounding with a carbon material, a carbon nano layer is capable of effectively increasing the conductivity of the transition metal oxide, improving the electron transport rate and then facilitating the improvement of rate performance of the material, more importantly, the composite elastic carbon material matrix can effectively avoid the agglomeration of transition metal oxide particles and buffer the expansion and contraction of its volume in repeated charge and discharge processes, thereby maintaining the structure consistency of the electrode material. Significant progress on improvement of the electrochemical performance of the electrode material has been gained.

### SUMMARY OF PRESENT DISCLOSURE

The disclosure provides a preparation method and application of a Fe₃C-doped graded porous carbon polymer potassium ion anode material. The method is capable of evenly coating the nano Fe₃C material while achieving the preparation of a polymer carbon-based material, and the prepared anode material has excellent comprehensive performance. Compared with the prior art, the method has the characteristics of simple operation, low cost, simple treatment process and safety and environmental protection.

In order to achieve the above object, the disclosure adopts the following technical solution:

I. A Method for Preparing a Fe₃C-doped Graded Porous Carbon Polymer Potassium Ion Anode Material, Comprising the Following Steps:

Step 1, weighing 1-2 g of iron nitrate (Fe(NO₃)₃), 0.2-2.2 g of lithium nitrate ((LiNO3) and 0.5-1.5 g of lithium hydroxide (LiOH), evenly stirring, then performing hydrothermal reaction for 550-720 min at 150-180° C., washing a product with deionized water, and drying in vacuum for later use; and

Step 2, preparing 0.5-4 g or 2-10 mL of polymer monomers into solution, then adding the above product into the solution, stirring, then evaporating at a lower temperature of 65-100° C., finally calcinizing for 2-5 h under the protection of nitrogen at 650-850° C., grinding into powders to obtain the Fe₃C-doped graded porous carbon polymer potassium ion anode material.

Preferably, in step 1, the hydrothermal temperature is 120-150° C.

Preferably, in step 1, the hydrothermal reaction time is 550-650° C.

Preferably, in step 2, the precursor of the polymer is a combination of one or two of aniline, pyrrole, thiophene and cellulose acetate, further preferably, aniline or cellulose acetate.

Preferably, in step 2, the evaporation treatment temperature is 65-75° C.

Preferably, in step 2, the temperature rising rate for heating to the calcination process is 2-10° C.·min⁻¹, further preferably 2-8° C.·min⁻¹, especially preferably 3-6° C.·min⁻¹.

Preferably, in step 2, calcination is performed at the temperature of 650-750° C., and calcination time is 2-3 h.

Due to adoption of the above technical solution, the disclosure has the beneficial effects:

1) by using the preparation method of the disclosure, it is realized that Fe₂O₃ coats the surface of a graphite material in the process of polymer graphitization, and in addition Fe₂O₃ is reduced into Fe₃C, which causes the pore diameter of the material to be increased and become rich. The preparation method of the disclosure has the characteristics of simple treatment procedure, no coating process, low synthesis cost, simple treatment process, and safety and environmental protection, and the like;

2) the surface coating of artificial graphite can be realized through a graphite layer formed by the polymer in the process of graphitization, the prepared composite anode material has excellent electrochemical energy storage performance, the obtained composite anode material is detected. By way of example 4, first discharge capacity is above 446.6 mAh·g⁻¹, and the coulomb efficiency after 100 cycles is above 88.7%. The comprehensive performance is excellent.

II. Characterization of Fe₃C-doped Graded Porous Carbon Polymer Potassium Ion Anode Material

The anode material prepared in example 4 is taken as an example.

The structure of the Fe₃C-doped graded porous carbon polymer potassium ion anode material provided by the disclosure is characterized.

The morphology of the product is observed through scanning electron microscope (SEM ULTRA Plus, German) and transmission electron microscope (TEM JEOL, JEM-2010, Japan).

1. Field Emission Scanning Electron Microscopy (SEM)

As shown in FIG. 1, the prepared Fe₃C-doped graded porous carbon polymer potassium ion anode material has a fluty, three-dimensional hydrogel-like structure which is composed of highly cross-linked carbon nano sheets and has a thickness of about 10 nm. The frame structure can effectively prevent the irreversible aggregation of carbon nano sheets.

2. Transmission Electron Microscopy (TEM)

As shown in FIG. 2, a flexible graphene-like structure is further observed through transmission electron microscope. It can be clearly seen from low-range TEM images that there are ultrathin filamentous graphite band with wrinkles, and Fe₃C black nano particles are coated therein.

3. Electrochemical Cycle Performance Test

The cycle capacity of a sample is 0.1 A·g⁻¹ under the potential window of 0.01-3.0 V. It can be seen from FIG. 3 that after 100 cycles, the capacity of the Fe₃C-doped graded porous carbon polymer potassium ion anode material reaches 227.8 mAh·g⁻¹.

4. Electrochemical Rate Performance Test

As shown in FIG. 4, under the conditions of 0.1, 0.2, 0.3, 0.5 1 A·g⁻¹, rate capacities of the Fe₃C-doped graded porous carbon polymer potassium ion anode materials are respectively 320.3, 136.1, 91.1. 44.5 [symbol] 7.6 mAh·g⁻¹.

### BRIEF DESCRIPTION OF THE DRAWINGS

FIG. 1 is an SEM image of a sample prepared according to the disclosure.

FIG. 2 is a TEM image of a sample prepared according to the disclosure.

FIG. 3 is a cycle capacity graph of a Fe₃C-doped graded porous carbon polymer potassium ion anode material prepared in example 4 as a potassium ion anode material under the current density of 0.1 Ag⁻¹.

FIG. 4 is a cycle capacity graph of a Fe₃C-doped graded porous carbon polymer potassium ion anode material prepared in example 4 as a potassium ion anode material under the current density of 0.1, 0.2, 0.3, 0.5 and 1 Ag⁻¹.

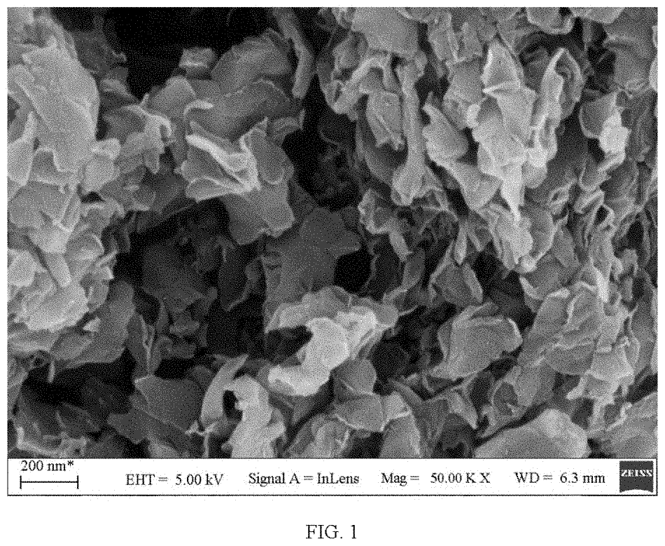

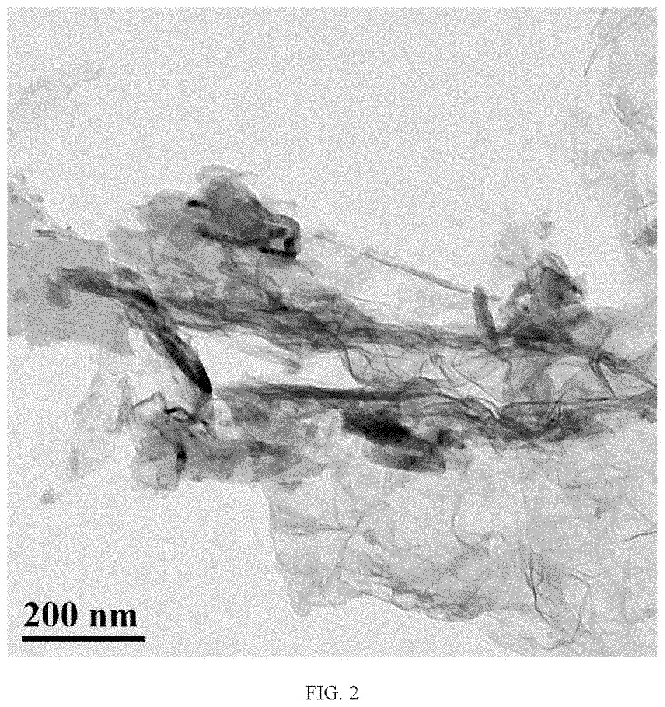

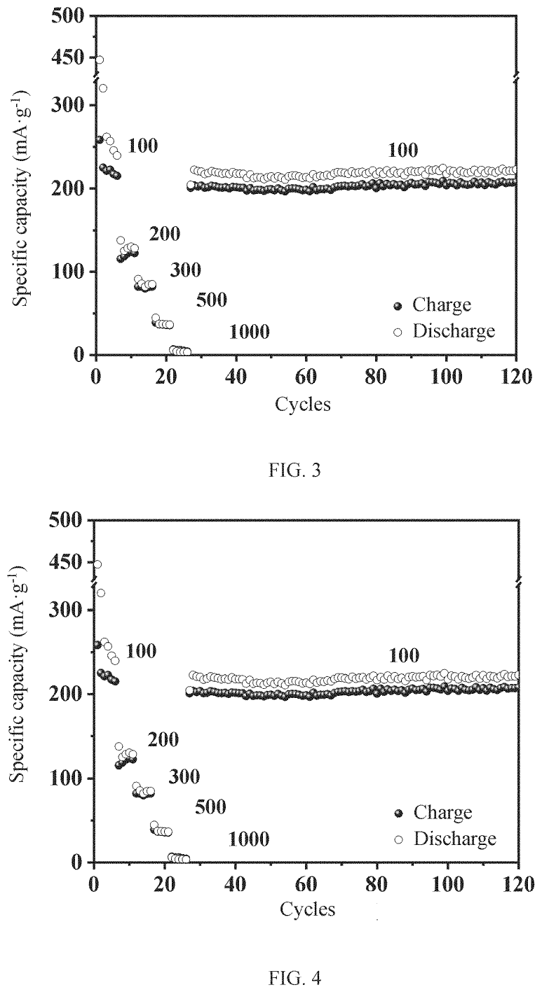

### DETAILED DESCRIPTION OF PREFERRED EMBODIMENTS

Next, the disclosure will be further described in detail in combination with specific examples, but is not intended to limit the protective scope of the disclosure.

### Example 1

1) 1 g of iron nitrate (Fe(NO₃)₃), 0.2 g of lithium nitrate ((LiNO₃) and 0.5 g of lithium hydroxide (LiOH) were weighed and evenly stirred, and then subjected to hydrothermal reaction for 550 min at 150° C. The product was washed with deionized water, and dried in vacuum for later use; and

2) the above product was added into 5 ml of aniline solution to be stirred, the aniline was polymerized, then the polymerized product was evaporated at a lower temperature of 65° C., finally the evaporated product was calcinized for 2 h under the protection of nitrogen at 650° C., and the calcinated product was grinded into powders to obtain the Fe₃C-doped graded porous carbon polymer potassium ion anode material.

### Example 2

1) 1 g of iron nitrate (Fe(NO₃)₃), 0.2 g of lithium nitrate ((LiNO₃) and 0.5 g of lithium hydroxide (LiOH) were weighed and evenly stirred, and then subjected to hydrothermal reaction for 550 min at 150° C. The product was washed with deionized water, and dried in vacuum for later use; and

2) 5 ml of pyrrole solution was added into the above product to be stirred and polymerized, then the polymerized product was evaporated at a lower temperature of 65° C., finally the evaporated product was calcinized for 2 h under the protection of nitrogen at 650° C., and the calcinated product was grinded into powders to obtain the Fe₃C-doped graded porous carbon polymer potassium ion anode material.

### Example 3

1) 1 g of iron nitrate (Fe(NO₃)₃), 0.2 g of lithium nitrate ((LiNO₃) and 0.5 g of lithium hydroxide (LiOH) were weighed and evenly stirred, and then subjected to hydrothermal reaction for 550 min at 150° C. The product was washed with deionized water, and dried in vacuum for later use; and

2) 0.5 g of cellulose acetate was prepared into solution, the above product was added into the solution to be stirred, then evaporated at a lower temperature of 65° C., finally the evaporated product was calcinized for 2 h under the protection of nitrogen at 650° C., and the calcinated product was grinded into powders to obtain the Fe₃C-doped graded porous carbon polymer potassium ion anode material.

### Example 4

1) 2 g of iron nitrate (Fe(NO₃)₃), 2.2 g of lithium nitrate ((LiNO₃) and 1.5 g of lithium hydroxide (LiOH) were weighed and evenly stirred, and then subjected to hydrothermal reaction for 720 min at 180° C. The product was washed with deionized water, and dried in vacuum for later use; and

2) 2 g of cellulose acetate was prepared into solution, the above product was added into the solution to be stirred, then was evaporated at a lower temperature of 65° C., finally the evaporated product was calcinized for 2 h under the protection of nitrogen at 650° C., and the calcinated product was grinded into powders to obtain the Fe₃C-doped graded porous carbon polymer potassium ion anode material.

### Example 5

1) 2 g of iron nitrate (Fe(NO₃)₃), 2.2 g of lithium nitrate ((LiNO₃) and 1.5 g of lithium hydroxide (LiOH) were weighed and evenly stirred, and then subjected to hydrothermal reaction for 720 min at 180° C. The product was washed with deionized water, and dried in vacuum for later use; and

2) 4 g of cellulose acetate was prepared into solution, the above product was added into the solution to be stirred, then was evaporated at a lower temperature of 65° C., finally the evaporated product was calcinized for 2 h under the protection of nitrogen at 750° C., and the calcinated product was grinded into powders to obtain the Fe₃C-doped graded porous carbon polymer potassium ion anode material.

We claim:

1. A Fe₃C-doped graded porous carbon polymer potassium ion anode material, wherein Fe₃O₂ prepared by iron nitrate is added into a plurality of polymers, the above mixture is evaporated at the low temperature of 65-100° C., and then the evaporated product is calcinated to obtain a potassium battery anode material.

2. A method for preparing a Fe₃C-doped graded porous carbon polymer potassium ion anode material, comprising the following steps:
(1) weighing 1-2 g of iron nitrate (Fe(NO₃)₃), 0.2-2.2 g of lithium nitrate ((LiNO₃) and 0.5-1.5 g of lithium hydroxide (LiOH), evenly stirring, then performing hydrothermal reaction for 550-720 min at 150-180° C., washing a product with deionized water, and drying in vacuum for later use; and
(2) preparing a certain mass or volume of polymer monomers into solution, then adding the above product into the solution, stirring, then evaporating at a lower temperature of 65-100° C., finally calcinizing for 2-5 h under the protection of nitrogen at 650-850° C., grinding into powders to obtain the Fe₃C-doped graded porous carbon polymer potassium ion anode material.

3. The Fe₃C-doped graded porous carbon polymer potassium ion anode material according to claim 2, wherein the plurality of polymers are preferably one or more of polyaniline, polypyrrole, polythiophene and cellulose acetates.

4. The Fe₃C-doped graded porous carbon polymer potassium ion anode material according to claim 2, wherein in the hydrothermal process, the temperature is maintained at 150-180° C., and the reaction lasts for 550-720° C.

5. The Fe₃C-doped graded porous carbon polymer potassium ion anode material according to claim 2, wherein in the heating process, the temperature rising rate is 2-10° C.·min⁻¹, the temperature is maintained at 650-850° C., and the heat preservation time is 2-5 h; more preferably, the temperature rising rate is 2-5° C.·min⁻¹, the temperature is maintained at 750-850° C., and the heat preservation time is 2-3 h.

6. Application of the Fe₃C-doped graded porous carbon polymer potassium ion anode material prepared by the method according to claim 2 as a potassium ion battery anode material.
